(19) United States
(12) Patent Application Publication
(10) Pub. No.: US 2025/0284970 A1
(43) Pub. Date: Sep. 11, 2025

(54) DECISION-MAKING METHOD AND APPARATUS BASED ON DEEP REINFORCEMENT LEARNING THROUGH PRIOR DATA AND SELECTIVE IMITATION LEARNING

(71) Applicant: FOUNDATION OF SOONGSIL UNIVERSITY-INDUSTRY COOPERATION, Seoul (KR)

(72) Inventors: Min Hae KWON, Seoul (KR); Chan In EOM, Seoul (KR); Dong Su LEE, Seoul (KR)

(73) Assignee: FOUNDATION OF SOONGSIL UNIVERSITY-INDUSTRY COOPERATION, Seoul (KR)

(21) Appl. No.: 18/766,147

(22) Filed: Jul. 8, 2024

(30) Foreign Application Priority Data
Mar. 5, 2024 (KR) 10-2024-0031177

(51) Int. Cl. G06N 3/092

(52) U.S. Cl. CPC G06N 3/092

(57) ABSTRACT

A deep reinforcement learning-based decision-making apparatus through prior data and selective imitation learning is disclosed. The deep reinforcement learning-based decision-making apparatus comprises a prior data collection unit configured to collect prior data from one or more other agents; a prior data processing unit configured to process the collected prior data into data including state, action, next state, and reward; and a policy learning unit configured to learn policy of an ego agent using the processed prior data and interaction data including state, action, next state, and reward obtained through real-time interaction with environment.

### CROSS-REFERENCE TO RELATED APPLICATIONS

This application claims the benefit of Korean Application No. 10-2024-0031177 filed on Mar. 5, 2024, in the Korean Intellectual Property Office. All disclosures of the document named above are incorporated herein by reference.

### TECHNICAL FIELD

The present invention relates to a deep reinforcement learning-based decision-making method and apparatus through prior data and selective imitation learning.

### BACKGROUND ART

For tasks that require decision-making based on interaction with the environment, deep reinforcement learning methods using deep neural networks are considered a promising method. In reinforcement learning, an agent learns a policy so that it can perform actions that can obtain optimal rewards in a specific environment. In the case of online reinforcement learning, policies are learned through real-time interaction with the environment.

In the case of conventional online reinforcement learning, it is suitable for tasks that can be simulated because it requires a lot of interaction, including exploration and trial and error with the environment, to iteratively improve the policy, but it has the problem of requiring high costs related to data collection.

In addition, in learning such as conventional autonomous driving, a decision-making method was used that allows the agent to imitate the trajectory information of the data as it is. However, in conventional imitation learning, there was a problem in that the action was imitated even if it included undesirable action, and thus this limits the range of available datasets.

### RELATED ART REFERENCE

Japanese Patent Application Publication No. 2023-017699 A

### DISCLOSURE

### Technical Problem

In order to solve the problems of the prior art described above, the present invention seeks to propose a deep reinforcement learning-based decision-making method and apparatus through prior data and selective imitation learning that ensures high sample efficiency and enables rapid convergence of policy networks.

### Technical Solution

In order to achieve the above-described object, according to one embodiment of the present invention, a deep reinforcement learning-based decision-making apparatus through prior data and selective imitation learning comprises a prior data collection unit configured to collect prior data from one or more other agents; a prior data processing unit configured to process the collected prior data into data including state, action, next state, and reward; and a policy learning unit configured to learn the policy of an ego agent using the processed prior data and interaction data including state, action, next state, and reward obtained through real-time interaction with the environment.

An objective function of the policy network of the ego agent may have a selective imitation learning term with a selective imitation learning weight that determines the degree of imitation according to the magnitude of the reward of data sampled from the processed prior data and the interaction data.

The selective imitation learning term in the objective function of the policy network may be added when the reward of the sampled data is greater than a preset threshold.

The processed prior data and the interaction data may be stored in a single replay buffer.

The processed prior data and the interaction data may be stored in different replay buffers.

The policy learning unit may learn policy by sampling the processed prior data and the interaction data from the single replay buffer or the different replay buffers by a preset number of samples.

According to another embodiment of the present invention, a deep reinforcement learning-based decision-making apparatus through prior data and selective imitation learning comprises a processor; and a memory connected to the processor, wherein the memory stores program instructions, when executed by the processor, configured to perform operations comprises collecting prior data from one or more other agents, processing the collected prior data into data including state, action, next state, and reward, and learning policy of an ego agent using the processed prior data and interaction data including state, action, next state, and reward obtained through real-time interaction with the environment.

According to another embodiment of the present invention, a deep reinforcement learning-based decision-making method through prior data and selective imitation learning comprises collecting prior data from one or more other agents; processing the collected prior data into data including state, action, next state, and reward; and learning policy of an ego agent using the processed prior data and interaction data including state, action, next state, and reward obtained through real-time interaction with environment.

### Advantageous Effects

According to the present invention, there is an advantage in ensuring high sample efficiency and rapid convergence of the policy network by using prior data and selective imitation learning in the policy learning of an agent.

### DESCRIPTION OF DRAWINGS

These and/or other aspects will become apparent and more readily appreciated from the following description of the embodiments, taken in conjunction with the accompanying drawings in which:

FIG. 1 is a diagram showing the configuration of a deep reinforcement learning-based decision-making apparatus through prior data and selective imitation learning according to a preferred embodiment of the present invention;

FIG. 2 is a diagram illustrating conventional online reinforcement learning;

FIG. 3 is a diagram illustrating an online reinforcement learning structure that considers prior data for policy learning according to this embodiment;

FIG. 4 is a diagram showing a general imitation learning process;

FIG. 5 is a diagram showing selective imitation learning according to this embodiment;

FIG. 6 is a diagram showing the management form of prior data and interaction data according to this embodiment;

FIG. 7 is a flowchart showing the interaction data storage process according to this embodiment;

FIG. 8 is a flowchart showing the policy learning process according to this embodiment; and

FIG. 9 is a diagram showing the objective function determination process when the reward of sampled data is greater than a preset threshold.

### DETAILED DESCRIPTION OF EMBODIMENTS

Since the present invention can make various changes and have various embodiments, specific embodiments will be illustrated in the drawings and described in detail in the detailed description. However, this is not intended to limit the present invention to specific embodiments and should be understood to include all changes, equivalents, and substitutes included in the spirit and technical scope of the present invention.

The terms used herein are only used to describe specific embodiments and are not intended to limit the invention. Singular expressions include plural expressions unless the context clearly dictates otherwise. In this specification, terms such as “comprise” or “have” are intended to designate the presence of features, numbers, steps, operations, components, parts, or combinations thereof described in the specification, but it should be understood that this does not exclude in advance the presence or addition of one or more other features, numbers, steps, operations, components, parts, or combinations thereof.

In addition, the components of the embodiments described with reference to each drawing are not limited to the corresponding embodiments and may be implemented to be included in other embodiments within the scope of the technical spirit of the present invention, and even if a separate description is omitted, a plurality of embodiments may be re-implemented as a single integrated embodiment.

In addition, when describing with reference to the accompanying drawings, identical or related reference numerals will be given to identical or related elements regardless of the reference numerals, and overlapping descriptions thereof will be omitted. In describing the present invention, if it is determined that a detailed description of related known technologies may unnecessarily obscure the gist of the present invention, the detailed description will be omitted.

In this embodiment, an online reinforcement learning structure that considers not only information obtained through interaction with the environment, but also prior data collected from other agents for learning is provided, and a method that imitates information that obtains high rewards to expand the range of available datasets is also provided.

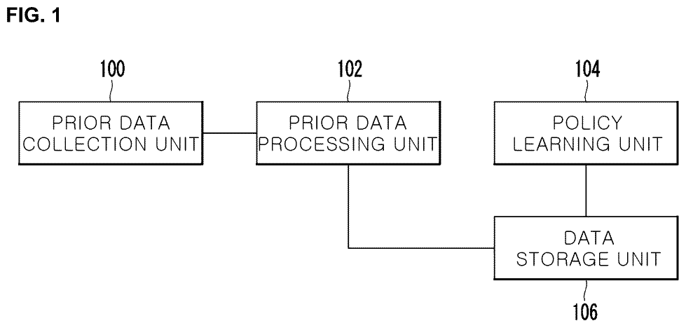

FIG. 1 is a diagram showing the configuration of a deep reinforcement learning-based decision-making apparatus through prior data and selective imitation learning according to a preferred embodiment of the present invention.

As shown in FIG. 1, the apparatus according to this embodiment may comprise a prior data collection unit 100, a prior data processing unit 102, and a policy learning unit 104.

The prior data collection unit 100 collects prior data from one or more other agents.

Here, prior data is defined as data collected from one or more agents that perform actions through policies with different decision-making methods.

Reinforcement learning problems can be defined as a Markov Decision Process (MDP).

MDP is defined as a tuple < [symbol] , [symbol] , [symbol] , [symbol] , γ>, where sₜ∈ [symbol] means the state information of the environment (state), aₜ∈ [symbol] means the action of the agent, T means the state transition probability, [symbol] means the reward function, and γ means the discount factor. Here, the agent aims to maximize accumulated rewards within a finite time range.

In MDP, there is an assumption that an agent is fully observable of all state information in the environment.

However, because complete observation of all state information is limited in the real environment, this embodiment defines the reinforcement learning problem through POMDP (Partially Observable MDP), which makes decisions based on partial state information.

POMDP is defined as a tuple < [symbol] , [symbol] , [symbol] , [symbol] , [symbol] , Ω, γ>, where oₜ∈ [symbol] means observable information of the agent (observation) and Ω means observation probability.

However, for convenience of explanation, the explanation below assumes that information that can actually be observed by an agent is also state information.

The prior data in this embodiment may include real-world data that does not follow the Markov decision process.

Accordingly, in order to utilize prior data, it is necessary to process the collected prior data based on the Markov decision process of the ego agent.

The prior data processing unit 102 processes the collected prior data into data including state, action, next state, and reward.

The policy learning unit 104 learns the policy of the ego agent using processed prior data and interaction data including state, action, next state, and reward obtained through real-time interaction with the environment.

According to this embodiment, the ego agent's policy is learned through an actor-critic network, and the objective function of the actor network may include a selective imitation learning term with a selective imitation learning weight having a larger value as the reward of the data sampled from the processed prior data and interaction data is higher.

Here, sampled data is data sampled from processed prior data and interaction data, and may be defined as experience information.

In the actor network objective function, a selective imitation learning term can be selectively added, for example, it may be added when the reward of the sampled data is greater than a preset threshold.

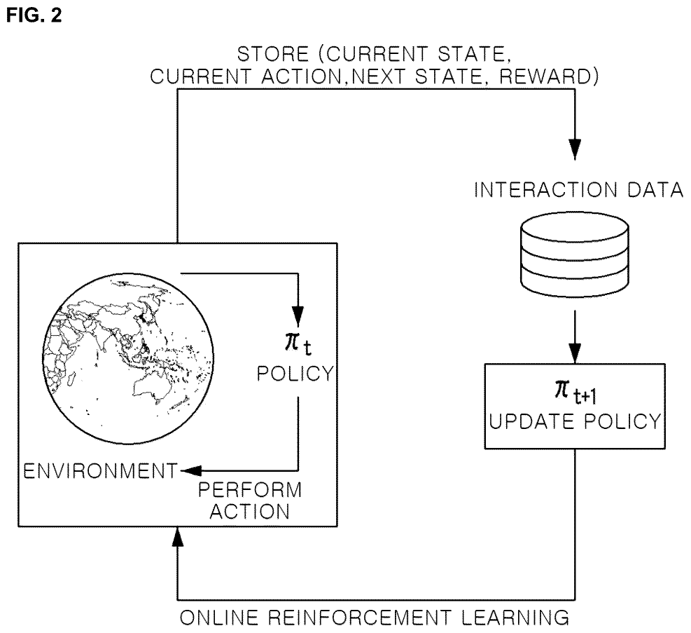

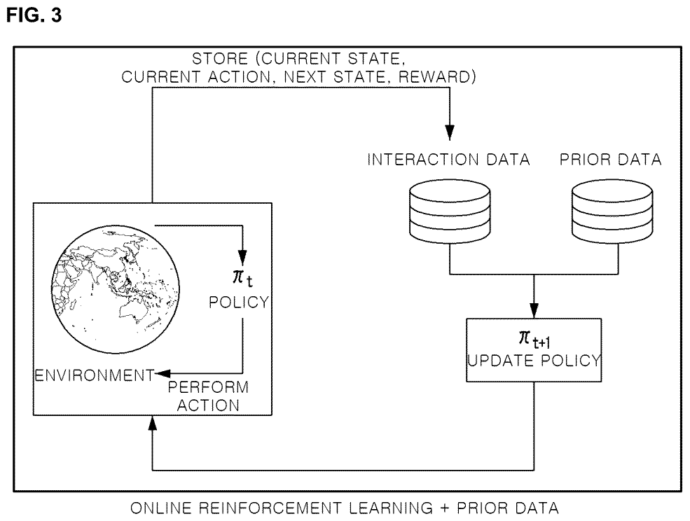

FIG. 2 is a diagram showing conventional online reinforcement learning, and FIG. 3 is a diagram showing an online reinforcement learning structure that considers prior data for policy learning according to this embodiment.

Unlike conventional reinforcement learning as shown in FIG. 2, as shown in FIG. 3, in this embodiment, prior data is additionally utilized in the online reinforcement learning process, thereby ensuring high sample efficiency and rapid convergence of the policy network is possible.

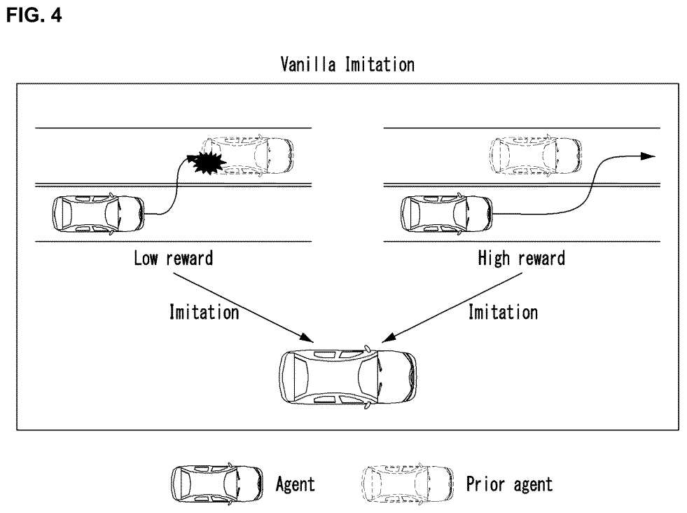

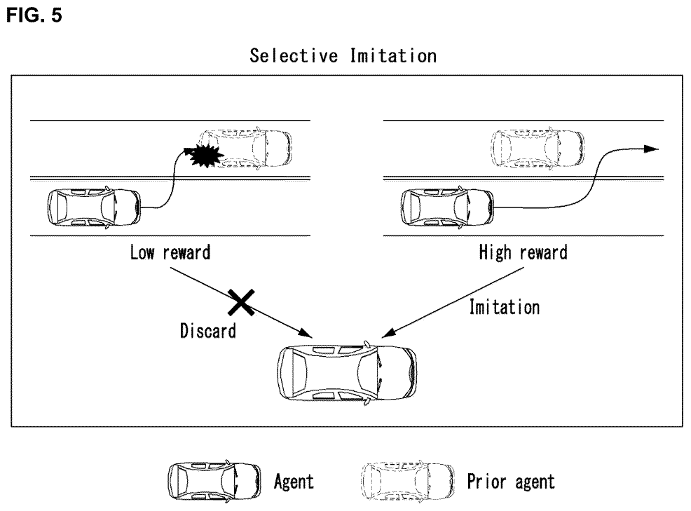

FIG. 4 is a diagram showing a general imitation learning process, and FIG. 5 is a diagram showing selective imitation learning according to this embodiment.

Referring to FIG. 4, in the case of general imitation learning, a decision-making model is learned that allows an agent to imitate the data of another agent (prior agent) as it is. Since the action is imitated even if it includes bad action, the range of available datasets is limited.

Therefore, in this embodiment, a method for selectively imitating only good action is proposed, as shown in FIG. 5, and through this, the range of available datasets can be expanded.

Referring again to FIG. 1, the policy learning unit 104 performs policy learning using data sampled from the data storage unit 106.

Here, the data storage unit 106 may be defined as a storage buffer that stores processed prior data and interaction data that the ego agent collects in real-time from the environment.

According to one embodiment of the present invention, the processed prior data and the interaction data may be stored in a single replay buffer or may be stored in different replay buffers.

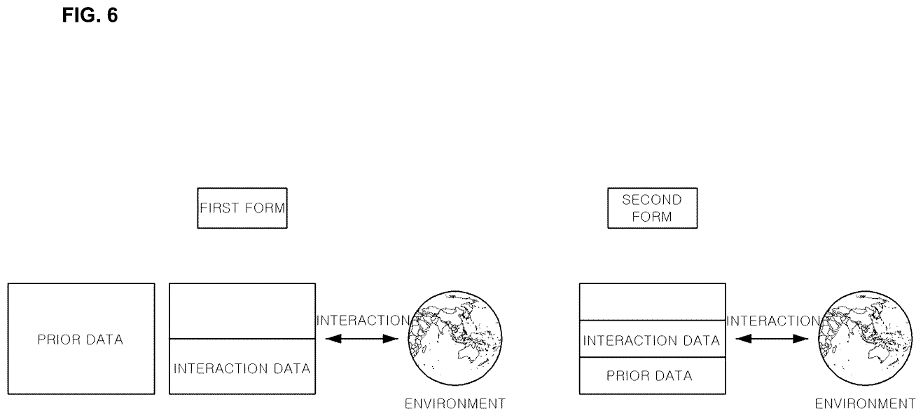

As shown in FIG. 6, prior data and interaction data may be managed separately from each other (first form) or integrated and managed (second form) depending on the case.

Regardless of whether they are stored in a single replay buffer or different replay buffers, the policy learning unit 104 samples the processed prior data and the interaction data by a preset number of samples to learn the policy.

Additionally, according to this embodiment, in order to increase data storage efficiency, data that has a similarity of more than a preset value to the processed prior data among the interaction data may be removed from the replay buffer.

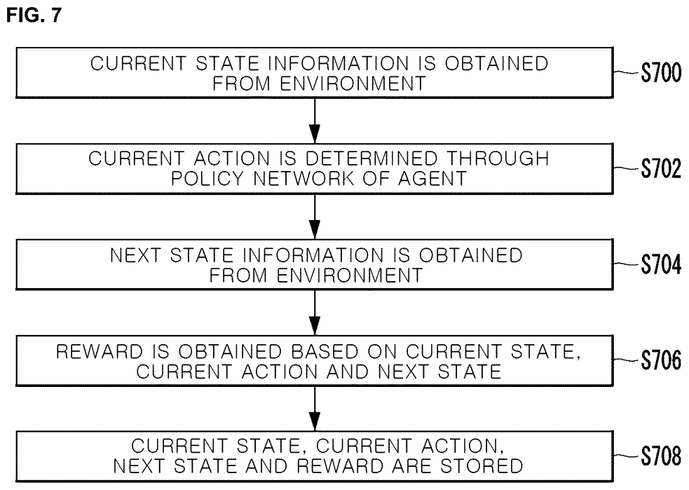

FIG. 7 is a flowchart showing the interaction data storage process according to this embodiment.

Referring to FIG. 7, the ego agent obtains current state information from the environment (step 700) and determines the current action through the agent's policy network (step 702).

After performing the action, the next state information is obtained from the environment (step 704), and a reward is obtained based on the current state, current action, and next state (step 706).

Thereafter, interaction data regarding the current state, current action, next state, and reward are stored (step 708).

Interaction data is accumulated and stored as learning progresses, and when the storage memory is used up, the data in the storage is replaced with the latest data.

At this time, the method of replacing old data with the latest data may be a FIFO (First in First Out) method that prioritizes removing old data, or it may be a method of comparing the similarity between interaction data to removing some among interaction data with high similarity (e.g., cosine similarity).

As described above, the policy learning unit 104 learns a policy using data sampled from processed prior data and interaction data, and determines the degree to imitate the sample based on the reward value of the sampled data.

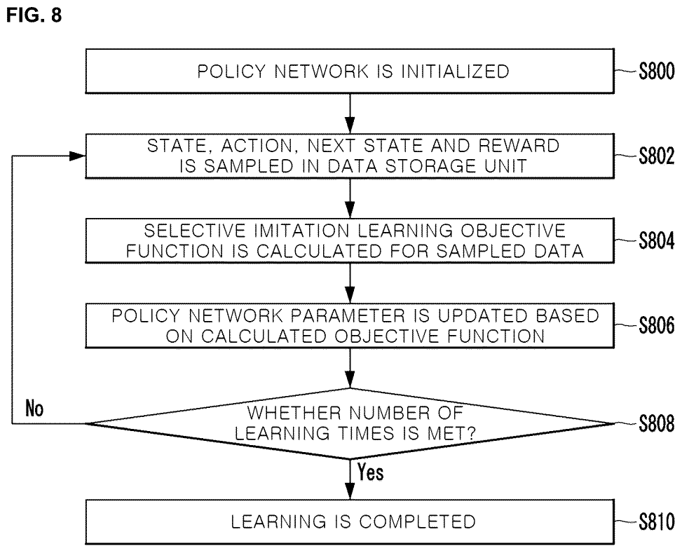

FIG. 8 is a flowchart showing the policy learning process according to this embodiment.

Referring to FIG. 8, policy network initialization is performed (step 800), and sampling including state, action, next state, and reward is performed in the data storage unit 106 (step 802).

Afterward, a selective imitation learning objective function is calculated for the sampled data (step 804), and the policy network parameters are updated according to the calculated objective function (step 806).

Next, it is determined whether the number of learning times has been met (step 808), and if the number of learning times has been met, learning is completed (step 810).

In this embodiment, an actor-critic approach to approximate policies and Q-functions over a continuous state and action space is adopted. An actor network π_{ϕ} can be considered a policy because it determines actions in a given state. The objective function of the actor network can be expressed as follows.

$$[ Equation 1 ]$$

$$L ( ϕ ) = {E}_{( {s}_{t} , {a}_{t} , {r}_{t} ) ∼ {D}_{on} ⋃ {D}_{prior}} [ - {Q}_{θ} ( {s}_{t} , {π}_{ϕ} ( {s}_{t} ) ) + f ( {r}_{t} ) {( {π}_{ϕ} ( {s}_{t} ) - {a}_{t} )}^{2} ]$$

Here, − [symbol] (sₜ, π_{ϕ}(sₜ)) is the traditional reinforcement learning objective function, (π_{ϕ}(sₜ)−aₜ)² is the imitation learning objective function, f(rₜ) is the selective imitation learning weight, f(rₜ)(π_{ϕ}(sₜ)−aₜ)² is the selective imitation learning term, (sₜ, aₜ) is (state, action), rₜ is the reward of the sampled data, Dₒₙ is the replay buffer that stores the interaction data, Dₚᵣᵢₒᵣ is the replay buffer that stores prior data, π_{ϕ} is the actor network, and [symbol] is the critic network.

The objective function of general reinforcement learning is to enable an agent to make decisions with high value, and the objective function of imitation learning is to ensure that the action π_{ϕ}(sₜ) determined by the agent is similar to the data sampled from the data storage unit 106.

In contrast, the objective function according to this embodiment is defined as a selective imitation learning objective function that variably determines the imitation learning weight according to the reward value rₜ of the sampled data.

In more detail, the objective function of the actor network according to this embodiment can be defined as including a selective imitation learning term with a selective imitation learning weight with a larger value as the revenue of the data sampled from the processed prior data and the interaction data is higher, as shown in Equation 1.

At this time, the selective imitation learning weight can be learned to imitate when the reward of the sampled data is positive, and to perform an action different from the action of the sampled data when the reward is negative, such as :f(rₜ)=rₜ.

In addition, the selective imitation learning weight can be defined as f(rₜ)=max (0, rₜ−c), where the selective imitation learning term in the objective function of the actor network is added when the reward of the sampled data is equal to or greater than a preset threshold C.

Meanwhile, the equation below represents the objective function of the critic network according to this embodiment.

$$[ Equation 2 ]$$

$$L ( θ ) = {E}_{( {s}_{t} , {a}_{t} , {s}_{t + 1} , {r}_{t} ) ∼ {D}_{on} ⋃ {D}_{prior}} [ {( {Q}_{θ} ( {s}_{t} , {a}_{t} ) - ( {r}_{t} + γ {Q}_{θ} ( {s}_{t + 1} , {π}_{ϕ} ( {s}_{t + 1} ) ) ) )}^{2} ]$$

Unlike the prior art, in this embodiment, the objective function is calculated using both prior data and interaction data.

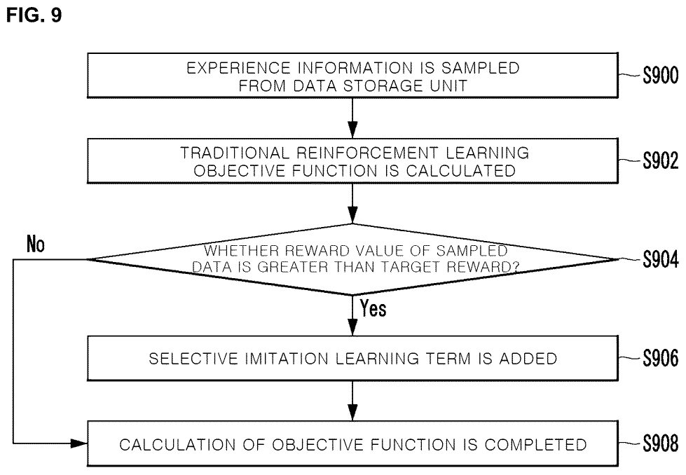

FIG. 9 is a diagram showing the objective function determination process when the reward of sampled data is greater than a preset threshold.

Referring to FIG. 9, data (experience information) is sampled from the data storage unit 106 (step 900).

First, a traditional reinforcement learning objective function is calculated for the sampled data (step 902).

It is determined whether the reward value of the sampled data is greater than the threshold (step 904), and if the reward value of the sampled data is greater than the threshold, a selective imitation learning term is added to the actor network objective function (step 906), and the calculation of the objective function is completed (step 908).

The aforementioned deep reinforcement learning-based decision-making method through the prior data and selective imitation learning can also be implemented in the form of a recording medium containing instructions executable by a computer, such as an application or program module executed by a computer. Computer-readable media can be any available media that can be accessed by a computer and includes both volatile and non-volatile media, removable and non-removable media. Additionally, computer-readable media may include computer storage media. Computer storage media includes both volatile and non-volatile, removable and non-removable media implemented in any method or technology for storage of information such as computer-readable instructions, data structures, program modules, or other data.

The above-described embodiments of the present invention have been disclosed for illustrative purposes, and those skilled in the art will be able to make various modifications, changes, and additions within the spirit and scope of the present invention, and such modifications, changes, and additions should be regarded as falling within the scope of the patent claims below.

1. A deep reinforcement learning based decision-making apparatus through prior data and selective imitation learning comprising:
a prior data collection unit configured to collect prior data from one or more other agents;
a prior data processing unit configured to process the collected prior data into data including state, action, next state, and reward; and
a policy learning unit configured to learn policy of an ego agent using the processed prior data and interaction data including state, action, next state, and reward obtained through real-time interaction with environment.

2. The decision-making apparatus of claim 1, wherein an objective function of policy network of the ego agent has a selective imitation learning term with a selective imitation learning weight that determines degree of imitation according to the magnitude of the reward of data sampled from the processed prior data and the interaction data.

3. The decision-making apparatus of claim 2, wherein the selective imitation learning term in the objective function of the policy network is added when the reward of the sampled data is greater than a preset threshold.

4. The decision-making apparatus of claim 1, wherein the processed prior data and the interaction data are stored in a single replay buffer.

5. The decision-making apparatus of claim 1, wherein the processed prior data and the interaction data are stored in different replay buffers.

6. The decision-making apparatus of claim 4, wherein the policy learning unit learns policy by sampling the processed prior data and the interaction data from the single replay buffer or the different replay buffers by a preset number of samples.

7. A deep reinforcement learning-based decision-making apparatus through prior data and selective imitation learning comprising:
a processor; and
a memory connected to the processor,
wherein the memory stores program instructions, when executed by the processor, configured to perform operations comprising,
collecting prior data from one or more other agents,
processing the collected prior data into data including state, action, next state, and reward, and
learning policy of an ego agent using the processed prior data and interaction data including state, action, next state, and reward obtained through real-time interaction with an environment.

8. A deep reinforcement learning-based decision-making method through prior data and selective imitation learning comprising:
collecting prior data from one or more other agents;
processing the collected prior data into data including state, action, next state, and reward; and
learning policy of an ego agent using the processed prior data and interaction data including state, action, next state, and reward obtained through real-time interaction with an environment.

9. The decision-making method of claim 8, wherein an objective function of policy network of the ego agent has a selective imitation learning term with a selective imitation learning weight that determines a degree of imitation according to the magnitude of the reward of data sampled from the processed prior data and the interaction data.

10. The decision-making method of claim 9, wherein the selective imitation learning term in the objective function of the policy network is added when the reward of the sampled data is greater than a preset threshold.

11. The decision-making method of claim 8, wherein the processed prior data and the interaction data are stored in a single replay buffer.

12. The decision-making method of claim 8, wherein the processed prior data and the interaction data are stored in different replay buffers.

13. The decision-making method of claim 11, wherein the learning of policy of an ego agent comprises learning policy by sampling the processed prior data and the interaction data from the single replay buffer or the different replay buffers by a preset number of samples.
